(19) United States
(12) Patent Application Publication
(10) Pub. No.: US 2025/0146877 A1
(43) Pub. Date: May 8, 2025

(54) INFRARED SHACK-HARTMANN WAVEFRONT SENSOR BASED ON CAVITY-COUPLED NANOANTENNAS

(71) Applicant: University of Notre Dame du Lac, South Bend, IN (US)

(72) Inventors: Edward KINZEL, South Bend, IN (US); Gary BERNSTEIN, South Bend, IN (US); Wolfgang POROD, South Bend, IN (US); Alexei ORLOV, South Bend, IN (US); Gergo SZAKMANY, South Bend, IN (US)

(21) Appl. No.: 18/839,353

(22) PCT Filed: Feb. 24, 2023
(86) PCT No.: PCT/US2023/063293

§ 371 Date: Aug. 16, 2024

Related U.S. Application Data
(60) Provisional application No. 63/268,478, filed on Feb. 24, 2022.

(51) Int. Cl. G01J 5/12; G01J 5/00; G01J 9/00

(52) U.S. Cl. CPC G01J 5/12; G01J 9/00; G01J 2005/0077

(57) ABSTRACT

An illustrative apparatus includes a first antenna suspended over a cavity at a first position and a first thermocouple connected to the first antenna. The first thermocouple supports the first antenna over the cavity and extends from the first antenna to a first location on an edge of the cavity. The apparatus further includes a second antenna suspended over the cavity at a second position different from the first position and a second thermocouple connected to the second antenna. The second thermocouple supports the second antenna over the cavity and extends from the second antenna to a second location on the edge of the cavity different than the first location.

### CROSS-REFERENCE TO RELATED APPLICATIONS

This application is a 371 National Stage application of International PCT Application No. PCT/US2023/063293, filed on Feb. 23, 2023 and entitled “INFRARED SHACK-HARTMANN WAVEFRONT SENSOR BASED ON CAVITY-COUPLED NANOANTENNAS”, which claims priority to U.S. Provisional Application No. 63/268,478 filed on Feb. 24, 2022 and entitled “INFRARED SHACK-HARTMANN WAVEFRONT SENSOR BASED ON CAVITY-COUPLED NANOANTENNAS”, each of which are hereby incorporated by reference in their entireties.

### STATEMENT REGARDING FEDERALLY SPONSORED RESEARCH OR DEVELOPMENT

This invention was made with government support under grant 80NSSC20K0918 awarded by the National Aeronautics and Space Administration (NASA). The government has certain rights in the invention.

### TECHNICAL FIELD OF THE DISCLOSURE

The disclosed technology generally relates to cavity-coupled nanoantennas, and more particularly relates to the formation, structure, and use of the cavity-coupled nanoantennas as a Shack-Hartmann wavefront sensor.

### BACKGROUND

Thermocouples (TCs) have proven invaluable in thermoelectric energy conversion. Their ability to generate electrical power, low cost, and high sensitivity make them ubiquitous in applications ranging from industrial control to home thermostats, including on-chip differential thermometry, energy harvesting, and detection of millimeter waves and infrared radiation. The operating principle of TCs is based on the Seebeck effect, which is the property of an electrical conductor to develop an electric field in response to a temperature difference across it. Different materials will exhibit this property to varying degrees, meaning for a given temperature gradient across two different materials a different voltage potential may be generated.

Thermocouples have been constructed from two dissimilar conductors (A and B) having different absolute Seebeck coefficients (S_{A} and S_{B}). An open-circuit voltage, V_{OC}, develops across the hot and the cold junctions in response to a temperature difference, ΔT. The open-circuit voltage is proportional to both this temperature difference and the difference in absolute Seebeck coefficients according to equation (1).

$${V}_{OC} = ( {S}_{A} - {S}_{B} ) Δ T \qquad Equation ( 1 )$$

Nanoscale thermocouples may be made from a single material and may be shape-engineered to contain one or more variations in their width along their length. The mono-metallic nanowire junctions resulting from the width variation(s) exploit a difference in the Seebeck coefficient that is present at these size scales. Such devices have a wide variety of uses and can be coupled with an antenna in order to serve as an infrared detector as described in U.S. Pat. No. 9,577,173, which is incorporated herein by reference in its entirety.

An article titled “Cavity-Backed Antenna-Coupled Nanothermocouples” (Szakmany, G. P., Orlov, A. O., Bernstein, G. H. et al. Cavity-Backed Antenna-Coupled Nanothermocouples. Sci Rep 9, 9606 (2019). https://doi.org/10.1038/s41598-019-46072-4), which is incorporated herein by reference in its entirety, reported a two-orders-of-magnitude improvement in the sensitivity of antenna-coupled nanothermocouple (ACNTC) infrared detectors. The electrical signal generated by on-chip ACNTCs results from the temperature difference between a resonant antenna locally heated by infrared radiation and the substrate. A cavity etched under the antenna may provide two benefits. It may eliminate the undesirable cooling of the hot junction by thermally isolating the antenna from the substrate. More importantly, careful cavity design may result in constructive interference of the incident radiation reflected back to the antenna, which may significantly increase the detector sensitivity. The article further presents the cavity-depth-dependent response of ACNTCs with cavity depths between 1 μm and 22 μm. When constructive interference is maximized, the thermal response may increase by 100-fold compared to devices without the cavity.

Another article titled “Mid-infrared Shack-Hartmann wavefront sensor fully cryogenic using extended source for endoatmospheric applications” (Clélia Robert, Vincent Michau, Bruno Fleury, Serge Magli, and Laurent Vial, “Mid-infrared Shack-Hartmann wavefront sensor fully cryogenic using extended source for endoatmospheric applications,” Opt. Express 20, 15636-15653 (2012), available at https://opg.optica.org/oe/fulltext.cfm?uri=oe-20-14-15636&id=239276), which is incorporated herein by reference in its entirety, relates to adaptive optics that may provide real-time compensation for atmospheric turbulence. The correction quality may rely on a key element: the wavefront sensor. The article discusses an adaptive optics system in the mid-infrared range providing high spatial resolution for ground-to-air applications, integrating a Shack-Hartmann infrared wavefront sensor operating on an extended source.

### SUMMARY

An illustrative apparatus includes a first antenna suspended over a cavity at a first position and a first thermocouple connected to the first antenna. The first thermocouple supports the first antenna over the cavity and extends from the first antenna to a first location on an edge of the cavity. The apparatus further includes a second antenna suspended over the cavity at a second position different from the first position and a second thermocouple connected to the second antenna. The second thermocouple supports the second antenna over the cavity and extends from the second antenna to a second location on the edge of the cavity different than the first location.

An illustrative apparatus includes a first antenna suspended over a first cavity and a first thermocouple connected to the first antenna. The first thermocouple supports the first antenna over the first cavity and extends from the first antenna to an edge of the first cavity. The apparatus further includes a second antenna suspended over a second cavity different from the first cavity and a second thermocouple connected to the second antenna. The second thermocouple supports the second antenna over the second cavity and extends from the second antenna to an edge of the second cavity.

An illustrative apparatus includes a single antenna suspended over a cavity. The cavity is generally semi-spherical in shape. The single antenna is the only antenna suspended over the cavity. The apparatus further includes a thermocouple connected to the single antenna. The thermocouple supports the single antenna over the cavity and extends from the single antenna to a location on an edge of the cavity.

### BRIEF DESCRIPTION OF THE DRAWINGS

FIG. 1 illustrates an example antenna-coupled nanothermocouple (ACNTC) in accordance with embodiments of the present disclosure.

FIG. 2 illustrates a graph of a measured frequency response of an example ACNTC in accordance with embodiments of the present disclosure.

FIG. 3 illustrates example geometric optics of an example spherical reflective cavity in accordance with embodiments of the present disclosure.

FIG. 4 illustrates an example ACNTC array in accordance with embodiments of the present disclosure.

FIGS. 5A-5C illustrate example far-field antenna patterns of three antennas from an ACNTC of the ACNTC array of FIG. 4 in accordance with embodiments of the present disclosure.

FIG. 6 illustrates example thermal responses as a function of angle of incidence of five antennas of an ACNTC of the ACNTC array of FIG. 4 pattern in accordance with embodiments of the present disclosure.

FIG. 7 illustrates an example graph showing specific detectivity of an ACNTC as a function of cavity diameter in accordance with embodiments of the present disclosure.

FIG. 8 illustrates an example system for using an ACNTC array in accordance with embodiments of the present disclosure.

FIG. 9 is a diagrammatic view of an example embodiment of a computing environment in accordance with embodiments of the present disclosure.

The drawings accompanying and forming part of this specification are included to depict certain aspects of the invention. A clearer conception of the invention, and of the components and operation of systems provided with the invention, will become more readily apparent by referring to the exemplary, and therefore non-limiting, embodiments illustrated in the drawings, wherein like reference numbers (if they occur in more than one view) designate the same elements. The invention may be better understood by reference to one or more of these drawings in combination with the description presented herein.

### DETAILED DESCRIPTION

The following description of example methods and apparatus is not intended to limit the scope of the description to the precise form or forms detailed herein. Instead the following description is intended to be illustrative so that others may follow its teachings.

Various infrared (IR) electro-optics for diverse applications exist for various purposes including remote sensing, secure communications, IR imaging, and multi-spectral imaging. These systems may be vulnerable to directed high-energy laser beams (HEL). When a system is illuminated by a HEL, it may be useful to rapidly identify the attributes of the incident energy; including wavelength, polarization, angle-of-incidence, and modulation.

Identification of the threat from HEL may allow for an appropriate response (e.g. shuttering optics, counterattacking source). Described herein are various embodiments of uncooled IR sensors with high responsivity and high bandwidth with the ability to quantify the attributes of a HEL attack. These sensors may use a resonant antenna to couple energy to a nanoscale thermocouple, and may be positioned over a cavity which provides thermal isolation. The cavity may further be designed as an optical element. The use of electromagnetic resonance makes the antenna-coupled nanothermocouples inherently sensitive to the wave nature of the incident radiation. The effective aperture area of the resonant antenna relative to the thermal mass may advantageously approach a maximum. This allows the antenna-coupled nanothermocouples to approach the performance of cooled devices, overcoming issues with prior thermal IR sensors that may be slow and insensitive. However, the embodiments herein maintain various advantages of uncooled IR sensors in terms of size, weight, power and cost (SWaP-C). Described herein are various embodiments of antenna-coupled nanothermocouples, and their potential as a HEL sensor.

Imaging in infrared wavelengths outside the visible spectrum may be used in defense and scientific optical systems. Various types of optics are not perfect and therefore require correcting in order to maximize their effectiveness. Described herein are various sensors that may be placed on an imaging chip whose function is to correct for nonidealities in an imaging system in wavelength regimes heretofore inaccessible to correcting systems, and at ultrahigh speeds that make them useful for a wide range of applications from astronomy to satellite and aircraft defense against laser (e.g., HEL) attacks.

An example nanoantenna based sensor described herein may provide the ability to resolve the angle of incidence of infrared energy. When such sensors are assembled in an array, the wavefront may be mapped. A resulting Shack-Hartmann type sensor may be designed to operate, for example, at wavelengths from 3-100 micrometers and at bandwidths greater than 200 kHz. This may be sufficient for characterizing IR optics and may be useful, for example, in adaptive optics in telescopes and/or the detection of laser beams. In particular, example nanoantennas as described herein may use one or more antennas suspended over one or more cavities, which may be used together in an array as a Shack-Hartmann type wavefront sensor to measure aberrations or other aspects of electromagnetic waves (e.g., IR).

A Shack-Hartmann (SH) wavefront sensor measures a wavefront of an incident beam. The wavefront of a beam is the shape of the fields that make up the beam. The wavefront makes up the information of an optical system. In a laser, the wavefront is flat. A point of light emits a spherical wavefront. These can be used to measure distortion in an optical system by looking for deviations from the ideal wavefront shape. The wavefront can be positioned in the focal plane for an optic or used to measure the distortion in a beam. In particular, SH sensors are useful with adaptive optics to correct for aberrations or atmospheric distortion. It is important to control for atmospheric distortion in optical systems used for any critical ranging or imaging system such as astronomy or defense.

In a conventional Shack-Hartmann sensor, light passes through a lenslet array and each portion of the light that hits each a point in the array is separately sensed. If the incident light has a zero degree angle of incidence, that zero degree angle of incidence causes the light to be focused by each lenslet straight down onto a detector. As a result of that zero degree angle of incidence, the dots projected onto the detector from each lenslet are evenly spaced. If the light has different or varying incident angles, the spots projected onto a detector by the lenslets will be unevenly spaced or otherwise will appear in different places than if the light has a zero angle of incidence. Thus, a detector may be used to determine the angle of incidences of light that hit the array as well as other properties of the light.

The cavity/antenna devices described herein may be individually capable of measuring the angle of incidence of light entering a cavity. Because a single cavity and its associated suspended antennas may measure angle of incidence of incoming light, an array of these devices may be used as a Shack-Hartmann sensor. Such a Shack-Hartmann sensor may ultimately measure the angle of incidence in different spatial portions of incoming light. Thus, an array of cavity/antenna devices described above may also be used to measure angle of incidence of different spatial portions of incoming light, and therefore be used as a Shack-Hartmann type wave front sensor.

Concepts related to Shack-Hartmann sensors may be applied to ACNTCs (which may be alternatively referred to as thermoelectrically coupled nanoantennas (TECNAs)) as described herein. Each lenslet/microlens/CMOS sensor may be replaced by a single cavity with multiple antennas. When a beam having a flat wavefront is normal to the substrate, the antenna positioned in the center of the cavity may be excited. When the incident beam is shifted off-normal to some angle θ (in radians), the position of the excitation at the antennas may be shifted by x (microns), where Δ=θ·D/4, and an offcenter antenna in the array may be excited, where D is the diameter of the spherical cavity.

For example, five antennas may be placed above a cavity designed to sense 45 micrometer wavelength electromagnetic waves. This provides 5 independent antenna patterns. By measuring the relative signal from these 5 antennas, the angle of incidence of incident radiation on the cavity may be determined with good precision. More antennas (potentially on different cavities) may provide redundant information that increases confidence of the angle of incidence and may provide information about a wider area of received electromagnetic waves (e.g., where the cavities form an array).

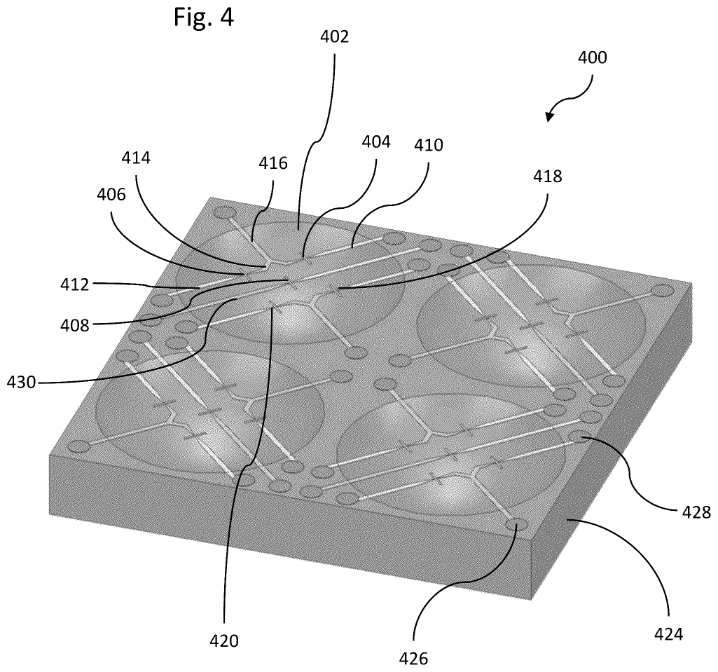

The local angle of incidence for a single reflector may be determined from the open-circuit voltage of the 5 antennas (e.g., using 8 terminals for 5 antennas as shown in FIG. 4). The cavities may be arranged on a chip to allow the angle of incidence to be resolved spatially. The aggregated signal provides information about the incident laser beam including, for example, a total angle of incidence and coherence information. The bandwidth may be sufficient for adjusting infrared adaptive optics for atmospheric disturbance. It may also serve as to determine an angle of incidence of a laser beam that is attacking, designating, or ranging an aerospace target.

As such, the angle of incidence of infrared (IR) radiation may be resolved by multiple nanoantennas suspended over a cavity etched in the substrate. An array having a sufficient number of these sensors in the focal plane of an optical system may be used to reconstruct a wavefront and resolve, and therefore correct, aberrations in an optical system. Doing so may be useful in improving the resolution, and therefore usefulness, of optical systems.

Previous Shack-Hartmann sensors may sense visible wavelengths using microlens arrays and CCD/CMOS arrays. However, the embodiments herein provide for sensing of IR wavelengths. IR wavelengths are not visible to humans and contain information about heat signatures of the objects being imaged. A significant advantage of the embodiments herein are that the embodiments may not require cryogenic cooling. There is enormous overhead size, weight, power and cost (SWAP-C) to cooling conventional sensors, which the embodiments herein may not require. Also, the sensors herein may be easily tunable to different wavelengths, which may not be done in conventional IR sensors.

Advantageously, the various embodiments of sensors herein are also very fast. This is advantageous for adaptive optics where the bandwidth should be significantly greater than the operational frequency. The sensor may be monolithic as opposed to sensors with separate lens arrays and photon sensor. At IR wavelengths, previous systems may have made significant compromises that the present embodiments avoid. Specifically, a microlens array for sensing IR may be formed of diamond making it expensive. Even if such a microlens array could be molded, it may also need to be aligned and calibrated with an expensive IR focal plane array (FPA). Such detecting elements in an FPA may be significantly more expensive at IR ranges with slow microbolometers or very expensive cooled photodetectors. Beyond performance, the TECNA described herein has significant advantages in terms of SWAP-C, which may be appealing for aerospace applications (e.g., laser warning receivers). As such, the embodiments described herein may particularly be suited to infrared (IR) electromagnetic wave sensing based on suspending a thermoelectrically coupled nanoantenna (TECNA) above a spherical or semi-spherical cavity. Such embodiments may further include various fabrication steps to create these devices with large uniformity yield. The antennas may be resonant and may be heated by incident radiation (e.g., IR). The absorbed radiation increases the temperature of a bimetallic junction located near/on the antenna (although single-metal geometric junctions may also be used in various embodiments). The temperature difference between the junction and the opposite end of one or more lead lines supporting the antenna generates an open-circuit voltage that scales linearly with the incident power on the antenna. This signal is spectrally dependent because of the antenna resonance. An advantage of this property is a fast thermal response, which can easily exceed 200 kHz because of low thermal mass. In various embodiments, the same device physics may also be used with a bolometric approach. The technology may be used for wavelengths anywhere from 3-100 micrometers (μm) and longer by adjusting antenna geometry of various embodiments (a capability that supports spectroscopic applications). For example, sensors described herein may be designed for wavelengths of 3 μm, 5 μm, 10 μm, 10.6 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, or 100 μm.

Cavities in the embodiments herein may thermally isolate the antenna and act as a reflective element. This reflective effect may allow a fraction of the incident power to be absorbed by the antenna and provides significant directivity. The aperture efficiency of such devices may exceed 50% for large diameter, D, cavities, with specific detectivity, D* (note: D* is not to be confused with D, diameter), values approaching 10\hat{ }9 Jones. Because a cavity acts as a parabolic reflector, a full-width half-max (FWHM) beam angle (in degrees) for the antennas may be approximately 70*wavelength/D.

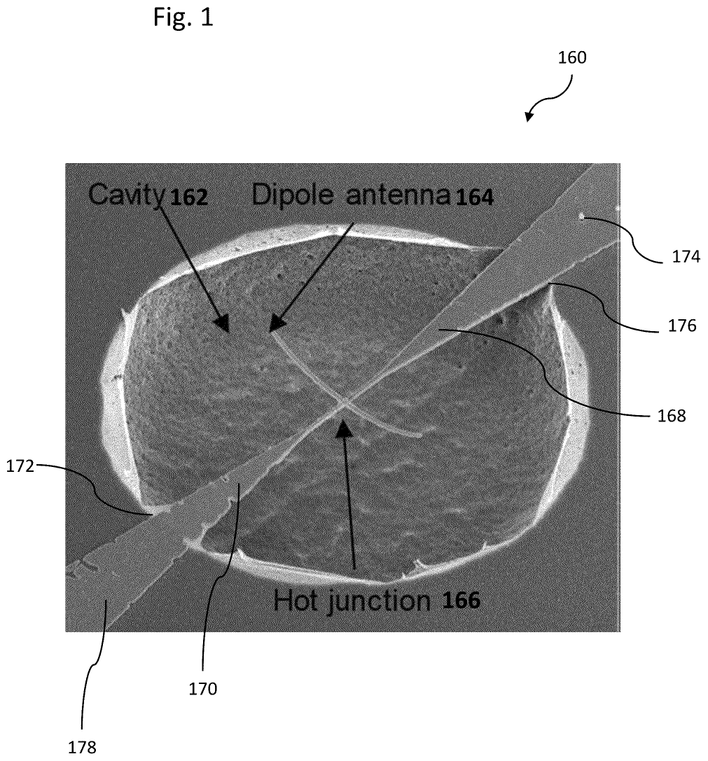

FIG. 1 illustrates an example antenna-coupled nanothermocouple (ACNTC) 160 in accordance with embodiments of the present disclosure. FIG. 1 specifically shows an example of the ACNTC 160 suspended above a quasi-spherical or semi-spherical cavity 162. A nanowire antenna 164, which is a dipole antenna in this embodiment, resonantly absorbs the incident infrared (IR) electromagnetic (EM) waves that come into contact with the ACNTC 160. Such radiation-induced currents heat the center of the antenna 164 where a hot junction 166 of the ACNTC 160 is located. The resulting temperature difference between the hot junction 166 and a cold junction of the ACNTC 160 results in a measurable open-circuit voltage due to the Seebeck effect. The antenna geometry determines the resonant wavelength and polarization response. The etched cavity 162 beneath the antenna 164 thermally isolates the antenna 164 while focusing incident radiation onto the antenna 164 which provides angle-of incidence (AOI) selectivity.

The antenna 164 may be suspended over the cavity 162 using a thermocouple that has different portions. For example, a first portion 168 may couple the antenna 164 to a first edge 176 of the cavity 162. The thermocouple may also include a second portion 174 that extends past the first edge 176, for example to connect with an electrical lead or lead line on a sensing chip. The thermocouple may also include a third portion 170 that couples the antenna 164 to a second edge 172 of the cavity 162 and may also include a fourth portion 178 that extends past the second edge 172, for example to connect with an electrical lead or lead line on a sensing chip. While the thermocouple of FIG. 1 shows connecting to two edges of the cavity 162, thermocouples may connect to different numbers of edges of the cavity 162 as desired in various embodiments. The antenna 164 is also shown in FIG. 1 generally at the center of the cavity 162. However, in various embodiments, the antenna 162 may be located at other positions or points over the cavity 162. For example, a cavity with a single antenna may have that antenna at a location other than the center or focal point of the cavity. FIG. 1 also shows only a single antenna 164 connected to the thermocouple. However, in various embodiments, more than one antenna may be connected to a single thermocouple.

The proliferation of HEL at infrared wavelengths may pose a risk to the structural integrity of space and aerial vehicles. However, the electro-optic systems that they rely on may be a greater vulnerability. The electro-optics are typically very sensitive to resolve thermal signals and may be easily saturated (temporarily blinded) or even permanently damaged by a HEL. Timely warning of an incident laser beam, including the detection, AOI, wavelength, and polarization, along with any modulation of the source, may be valuable for shuttering electro-optics, identifying the source of the threat, and/or disrupting the HEL. For aerospace systems such as drone swarms or nano satellites, it may be advantageous to have sensors like those described herein that may be packaged with low size, weight, power and cost (SWaP-C). A conventional detector (cooled or uncooled) may integrate irradiance over an area, losing all directional, spectral, and polarization information. These attributes may be recovered using filtering elements and conventional optics, which may be expensive and add significant size and weight. In general, there may be a tradeoff between cooled detectors (e.g. MCT or QWIP) which may use large, heavy, and expensive cryogenics to overcome dark current, or uncooled detectors (bolometeric, pyroelectric, and/or thermoelectric) which may be slow because the mass heated by the incident radiation has thermal inertia. In addition to this sluggishness, bolometric solutions may require biasing which may introduce additional noise, and pyroelectric detectors require modulation (e.g. chopping) which may reduce the time to response and consumes power. One of the advantages of thermoelectric detectors may be that because they are unbiased, only Johnson noise is introduced into the response.

An ACNTC is a thermoelectric detector with an effective absorptivity exceeding unity. This is possible at the antenna resonance, where the effective aperture area exceeds the projected area of the antenna. This phenomenon may allow for dramatic improvement in the ratio of the effective absorption area to the thermal mass (120 m²·K/J). While multiple junctions may be formed at a single antenna, a small mass of the antenna relative to TC may maximize the responsivity of the detector with a single junction. The very low thermal mass may lead to a very short response time—up to 10,000× faster than bolometers. The embodiments herein may therefore provide for a frequency response of suspended antenna arrays that can exceed 1 MHz. An important aspect of this sensitivity may be the thermal resistance of the thermocouples and/or lead lines. This property scales inversely to the thermal conductivity of the thermocouples and/or lead lines. In various embodiments, the cavities may be configured as a vacuum or near vacuum (e.g., air is removed from the cavities and a seal applied over the cavities to form a vacuum) so that performance of the nanodevices described herein may be improved by minimizing losses to air. Such losses may significant at the dimensions of cavities described herein. For example a three-fold increase in the performance of an ACNTC in vacuum for a smaller cavity (e.g., 1 to 49 μm cavity) may be achieved by using a vacuum, while a ten-fold or more increase in performance of an ACNTC may be achieved using larger cavities (e.g., 50 μm cavities or larger) with a vacuum.

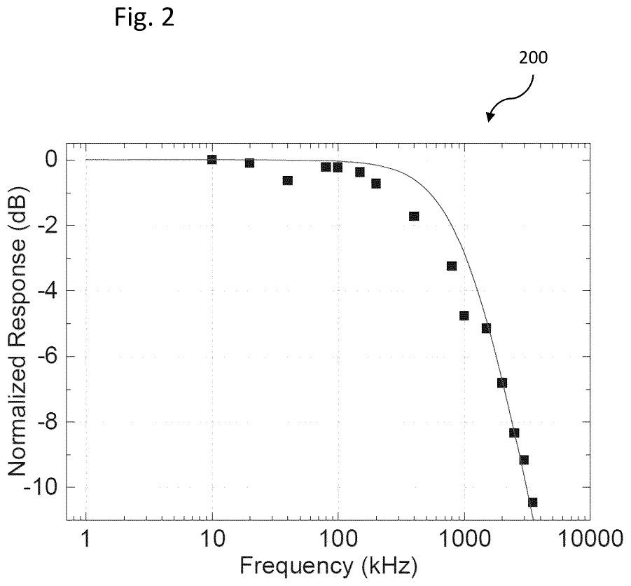

FIG. 2 illustrates a graph 200 of a measured frequency response of an example ACNTC in accordance with embodiments of the present disclosure. FIG. 2 specifically 200 shows a normalized V_{OC} response of a suspended ACNTC as a function of the modulation frequency of a CO₂ laser source. Even this measurement may be limited by the speed of an acousto-optic modulator used for the modulation and not by the response of the ACNTC. The thermal resistance may be limited by the thermal resistance of the feed lines and a cutoff frequency for a −3 dB response may be beyond 3 MHz (e.g., a sub-μs response time). Such performance may be comparable with cooled MCT detectors and may be orders of magnitude greater than typical bolometers with speeds of about 300 Hz. Such short response times of the ACNTCs described herein therefore open applications in secure communications and ultrafast thermal imaging.

In various tests performed, ACNTCs fabricated according to the embodiments herein have demonstrated functionality at 10.6 μm (28.3 THz) and 500 μm (600 GHz). The principle of operation may be the same at any wavelength, but the design and placement of the ACNTCs is different for various antenna lengths. ACNTCs using a CO₂ laser may operate, for example, at λ=10.6 μm with an intensity of E=1.42 W/cm². The V_{oc} responses may be measured by a lock-in amplifier or a DC voltmeter, for example. The calculated voltage responsivity for these devices may be 12.5 V/W with a specific detectivity D* of approximately 5×10⁷ Jones. The latter may be based on the effective area of the nanoantenna.

However, the advantages of the ACNTCs described herein may be further leveraged by improved engineering of the cavity, such that devices have dramatically higher cutoff frequencies; polarization/AOI/wavelength sensitivities; and/or, by varying antenna length, operation from the mid-IR to THz.

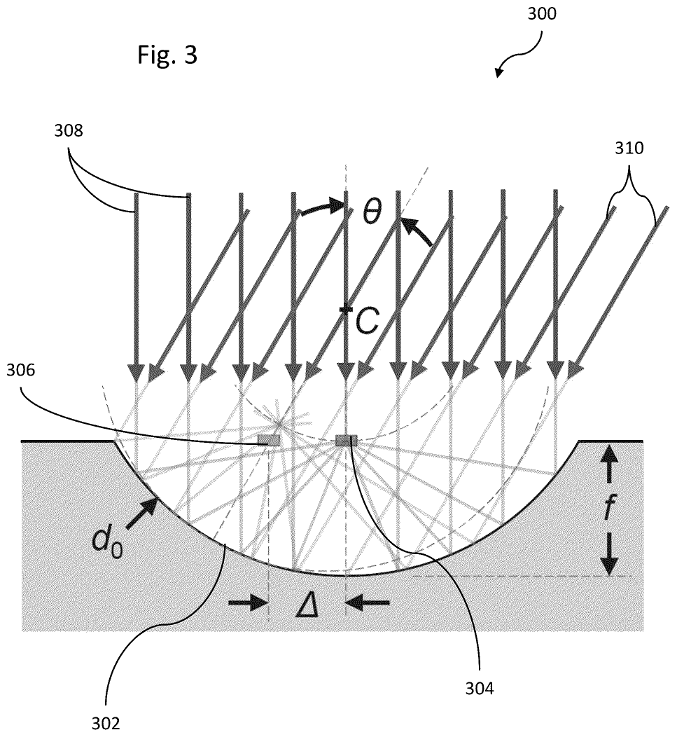

FIG. 3 illustrates example geometric optics 300 of an example spherical reflective cavity in accordance with embodiments of the present disclosure. In addition to providing thermal isolation, the cavities may serve as integrated electromagnetic elements. While the cavities may be only a few wavelengths wide in various embodiments, insight may still be gained from geometric optics. FIG. 3 shows the principal of a simple spherical mirror 302 (e.g., a reflective cavity) focusing incident radiation of a first wave 308 having a first angle of incidence (AOI) and incident radiation of a second wave 310 having a second AOI to two different points 304 and 306 based on the waves respective angles of incidence. The points 304 and 306 may correspond to the locations where an antenna is mounted in the embodiments described herein. In particular, radiation incident from an angle θ on a spherical mirror of diameter D is focused to a plane at f=D/4 from the center and offset from the optical axis by a distance Δ=θ·D/4. The reflector produces power ϕ=η E·A at the focus, where E is the irradiance, A is the projected area of the reflector diameter, A=(3πD²/16) cos θ and η is an efficiency that captures the effects of diffraction, standing wave interference, and mismatches to the pattern of the antenna. For example, assuming a cavity with a vacuum, the area normalized performance may scale with D\hat{ }1.5, or without normalizing to area the performance may scale with D\hat{ }3.5. For simple dipoles above perfectly spherical cavities at normal incidence, n is predicted by simulation to be on the order of 0.35. Such characteristics may be true for large cavities where the cavity diameter D>wavelength, and smaller cavities where D is approximately equal to wavelength/2 may have efficiencies>1 as these devices may absorb more energy that is incident on the cavity opening due to the coupled resonance (though these devices may not have AOI selectivity). Various spherical cavities may also be aberrated for off-normal incidence illumination, with the focal plane curving away from the datum defined by f=D/4. Thus, various geometries may be obtained based on how the cavities are formed to achieve different effects from those shown in FIG. 3 from etching to flatten the focal plane. In other words, different shapes of cavities may be used than strictly spherical cavities, as the focal plane for a spherical cavity may be curved so that light from larger angles is reflected and focused above the focal plane at normal incidence (e.g., Pertzval field curvature). In this way, cavity geometry may be optimized to be non-spherical, such that a common cavity geometry can be used for many different angles of different incident light. Thus, the power or other aspects of signals detected at various antennas suspended over a cavity (e.g., at the points 304 and/or 306) may be used to determine an angle of incidence of light entering the cavity and may be optimized using different shapes of cavities. FIG. 4 illustrates an example ACNTC array 400 in accordance with embodiments of the present disclosure. As shown, multiple antennas may be suspended above a single cavity. Each antenna may respond to angles of incidence corresponding to when the focal point of the reflector/cavity is coincident with its location. In particular, the array 400 includes 4 different ACNTCs each having 5 antennas and 8 lead lines connected to the thermocouples associated with each ACNTC.

For example, a first ACNTC has a first antenna 404 suspended over a cavity 402 at a first position. The cavities, including the cavity 402, may be formed in a substrate 424. In an array of ACNTCs like shown in FIG. 4, the ACNTCs may be generally pointed in a same direction. However, in various embodiments, the ACNTCs may be pointing or oriented in different directions or residing in different planes so that a device may have multiple ACNTCs that react different to IR radiation (e.g., different waves may be more or less incident on different ACNTCs of an array). With such embodiments with ACNTCs and their respective antennas looking in different directions, each antenna of a different ACNTC will produces a different voltage from a given wave to which it is exposed. A computer, processor, or other circuitry may then determine an angle of incidence (AOI) of that wave/beam by comparing these voltages from the different antennas to measured and/or simulated responses from the array since the antennas receive the wave/beam at different angles. Returning to the configuration of FIG. 4, a first thermocouple 410 is connected to the first antenna 404, wherein the first thermocouple 410 supports the first antenna 404 over the cavity 402 and extends from the first antenna 404 to a first location on an edge of the cavity 402. A second antenna 408 is suspended over the cavity 402 at a second position different from the first position of the first antenna 404. A second thermocouple 430 is connected to the second antenna 408, wherein the second thermocouple 430 supports the second antenna 408 over the cavity 402 and extends from the second antenna 408 to a second location on the edge of the cavity 402 different than the first location on the edge of the cavity 402.

As described herein, each of the first antenna 404 and the second antenna 408 may be configured to produce heat upon exposure to an electromagnetic wave. The first thermocouple 410 and the second thermocouple 430 may then convert the heat produced by the first antenna 404 and the second antenna 408, respectively into electrical signals that may be transmitted to electrical leads on the array 400 outside of the cavity 402. Example electrical leads 426 and 428 are shown in FIG. 4. The electrical signal output by the first thermocouple 410 in response to electromagnetic waves of a first AOI received at the array 400 may be different than the electrical signal output by the first thermocouple 410 in response to a electromagnetic wave of a second AOI, as the power absorbed by the first antenna may be different for different types of waves. Similarly, the first antenna 404 and the second antenna 408 may output different electrical signals based on the same electromagnetic wave hitting the array 400, due to their different placement over the cavity 402 and as described herein.

The first thermocouple 410 may be a portion of a thermocouple, such that an additional portion 416 further extends from the first antenna 404 to a third location on the edge of the cavity 402. One or more additional portions of a thermocouple may be configured to and used so that voltages of two connected antennas may be measured independently. In other words, a portion of thermocouple may be or may function as a voltage measurement tap. Similarly, the second thermocouple 430 may include an additional portion that further extends from the second antenna to a fourth location on the edge of the cavity 402. As described herein each of the first antenna 404 and the second antenna 408 may be dipole antennas. The dipole antennas may also be polarized.

In various embodiments, dipole antennas may be used as they are configured to be sensitive to polarization (e.g., dipole antennas may only respond to radiation with an electromagnetic field parallel to a long axis of the antenna). In various embodiments, spiral antennas may also be used, which may have minimal sensitivity to linear polarization but may be sensitive to circular polarization. As such, different antennas may be used for different applications and in different embodiments (e.g., such as using spiral antennas for communications applications and devices). In various embodiments, any other type of antenna than spiral or dipole antennas may also be used.

A third antenna 406 may be suspended over the cavity 402 at a third position different from both of the first position of the first antenna 404 and the second position of the second antenna 408. The third antenna may be connected to the first antenna 404 and/or the portion 416 of the first thermocouple 410 via an additional portion 414 of the first thermocouple 410. The portion 414 may extend from the first antenna 404 and/or the portion 416 to the third antenna 414. Another portion 412 of the first thermocouple 410 may extend from the antenna 406 to yet another edge of the cavity 402, as shown in FIG. 4. Such multi-antennas over one cavity may significantly increase the fill factor of a sensor design used as an IR sensor. As further shown in FIG. 4, multiple cavities with their own respective antennas may be configured into an array as described herein. In each of the cavities, one antenna may be located at or near a focal point of the respective cavity, and other antennas may be located at other positions over the respective cavity.

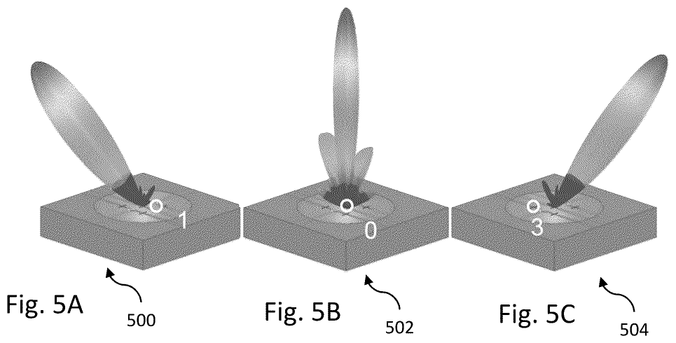

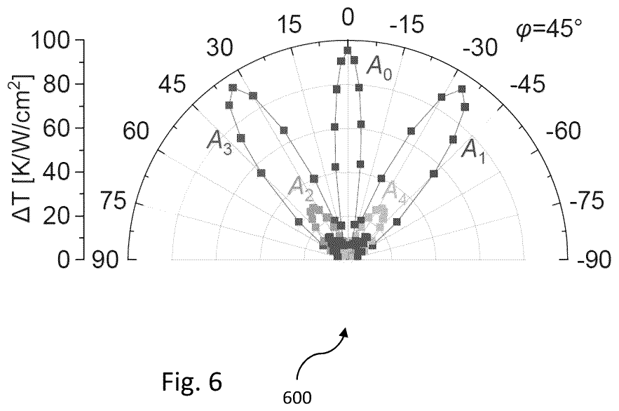

FIGS. 5A-5C illustrate example far-field antenna patterns of three antennas from an ACNTC of the ACNTC array of FIG. 4 in accordance with embodiments of the present disclosure. FIG. 6 illustrates example thermal responses as a function of angle of incidence of five antennas of an ACNTC of the ACNTC array of FIG. 4 pattern in accordance with embodiments of the present disclosure. In particular, FIGS. 5A-5C and 6 show the results of full-wave electromagnetic simulation of example devices coupled a thermal model (e.g., ANSYS HESS/Mechanical). FIGS. 5A-5C specifically show the angular dependence of the absorption for three of the antennas in a five-antenna array (e.g., associated with one of the cavities of FIG. 4) above a single D=46 μm cavity, where D is the diameter of the cavity. In FIG. 4, the antennas may be referred to or numbers 0-4 (e.g., the antenna 408 is antenna 0, the antenna 404 is antenna 1, the antenna 406 is antenna 2, antenna 420 is antenna 3, and antenna 418 is antenna 4). As such, FIGS. 5A-5C correspond to the antennas 1, 0, and 3, respectively, to show angularly resolved temperature increase at the antennas as further demonstrated in FIG. 6. In this example, two of the five antennas (e.g., antennas 2 and 4—or the antenna 406 and the antenna 418 in FIG. 4) may not respond (or may not significantly respond) to radiation in the plane (as shown in FIG. 6) but may respond if the plane of incidence was rotated (e.g., rotated 90°).

The angular sensitivity of an antenna is directly related to the gain—the higher the gain the more directional is the antenna response. As such, three or more antennas may receive a signal to identify its direction in various embodiments. This may introduce a tradeoff in the design of the antenna array, as different numbers of antennas may be used to span the 2π Sr hemisphere scales with different levels of sensitivity. For example, the initial simulated devices may have a FWHM pattern of ˜0.35 Sr. Assuming 3 antennas are excited this may dictate a utilization of 54 antennas. Twice this may be used to resolve the linear polarization state. Assuming 5 antennas per reflector as an example, this may provide full angular/polarization coverage within an area of Aₐ=0.065 mm² for reflectors on a square 55 μm pitch. Through substrate vias (e.g., at locations of leads of FIG. 4 such as 426 and 428) may be used to connect the antennas to read-out circuitry (e.g., a processor) on the back side of the device or elsewhere off chip. The devices may be similarly scaled to resolve wavelength. For this example, the 15 individual wavelength bands (determined by the antenna size) may be covered in a 1 mm×1 mm device (with polarization and AOI coverage).

Calibration may be performed to map the individual antenna responses to the parameters, fully defining the state of the incident laser beam (or other radiation source).

In various embodiments, the material of the lead lines, through silicon vias (TSVs), etc. that connect a thermocouple to other read-out circuitry, or the material of the thermocouples themselves, may be made of a metal, a semiconductor (e.g., Bismuth Tellurium), or any other suitable material. For example, the material may be selected for a desired Seebeck coefficient (e.g., a Bismuth Tellurium semiconductor material has a greater Seebeck coefficient than many metal materials that may be used as a lead line or thermocouple) and/or for a desired beneficial electrical conductivity to thermal conductivity ratio. A material for the lead lines and/or thermocouples may also be selected for various embodiments that have a desired thermal resistance depending on the planned application or use of the device.

ACNTCs as described herein may have an extremely low profile. The reflectors may be directly integrated into a substrate (e.g., as shown in FIG. 1 and the substrate 424 of FIG. 4) for a total device depth of less than 25 μm. This is a significant advantage over other systems with integrated refractive optics and embodiments of the apparatuses described herein may also be used with flexible substrates. In addition, read-out circuitry on the substrate may have minimal power requirements because of the lack of biasing. These factors yield an integrated multi-cavity system to be conformed to an aerospace system or other systems with demanding space constraints, further minimizing SWaP-C while allowing the antennas to measure incident HEL from greater than 2π Sr. The substrate 424 may be formed out of various materials, such as a silicon (Si) substrate that is suitable for serving as a printed circuit board (PCB) for other read-out electronics on an opposite side of the substrate 424 from the cavities.

In various embodiments, the substrate 424 or a substrate used in other embodiments may be transparent or partially transparent to electromagnetic waves such as IR light (e.g., some IR light may pass through the substrate 424 rather than be reflected by a surface of a reflective cavity formed in the surface of the substrate 424). In various embodiments, IR light that is directly incident on the substrate 424 may be particularly likely to pass into the substrate 424 through the surface of the cavities, for example. This may occur where the substrate 424 is transparent or partially transparent to IR light, such as various types of silicon (Si) substrates. Such IR light may pass through the substrate 424 and reflect off of a back side surface the substrate 424 back toward the cavities and antennas suspended over the cavities. As such, the antennas and corresponding read-out circuitry may be configured to pick up and/or measure a set of characteristic fringes associated with the IR light reflected back through the substrate 424 from the back surface of the substrate. For example, these fringes may be identified and/or isolated by measuring a response of one or more antennas as a function of the angle of incidence (AOI) of the IR light arriving at the substrate 424 and/or the antennas/cavities associated therewith. For example, using a model that assumes a coherence length of the IR waves that is much thicker than the substrate, the fringes from the reflection on the back side of the substrate may be identified/measured/isolate from the signals measured by the antennas.

Such information may be valuable, as the identification and presence of these fringes in the data/signals collected by the antennas may represent an indication that the incident radiation field is coherent. For very short pulses of incident radiation, such an effect of the fringes may disappear, may not be present, or may be minimal due to the time for the IR light to travel through the substrate 424 being longer than the pulse length (time) of the IR light to which the sensors are exposed. For an antenna array that is designed to resolve responses from many angles (e.g., with many different cavities pointed in many different directions), these fringes may emerge as incident radiation may inevitably directly hit at least one cavity/sensor. The fringes may further be recognized by using models or other signal processing that are configured to recognize such fringes (e.g., machine learning models may be trained to recognize such fringes) so that the fringes can be accounted for, measured, removed, etc. from the output of such antenna arrays. As such, a TECNA array may be used to resolve/determine the coherence for a continuous/constant wave (CW) laser and/or the pulse length for an ultrafast laser.

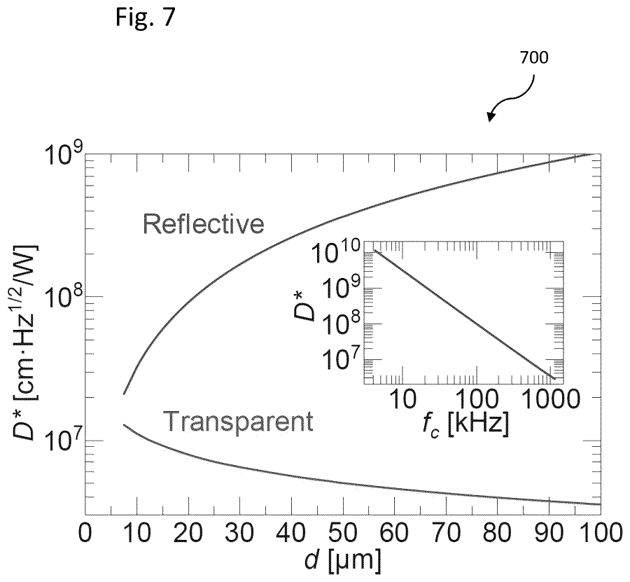

FIG. 7 illustrates an example graph 700 showing specific detectivity of an ACNTC as a function of cavity diameter in accordance with embodiments of the present disclosure. In addition to providing directionality, the spherical reflector may dramatically improve the radiation gathering efficiency of the antennas described herein. FIG. 7 shows the calculated cavity area-based D* as a function of the cavity diameter for the case of an n of approximately 0.15 reflective (focusing) and one that only provides thermal isolation. As the diameter increases, the thermal resistance of the feed lines increases, improving the responsivity. The Johnson noise also increases due to a higher DC resistance along with the footprint which lowers D* for a transparent cavity. However, the increased gain from the reflector improves the response and the D* would exceed 10⁹ for a D=100 μm cavity. This is for a single antenna; D* may be further multiplied by the number of antennas per cavity. The inset of FIG. 7 also illustrates that like other IR detectors, ACNTCs suffer from a gain/bandwidth tradeoff: fast response times require the rapid heating and cooling of the hot junction, which in turn requires low thermal resistivity. However, this results in a loss of sensitivity due to less heating. In ACNTCs with feedlines of a constant area, the thermal resistance advantageously scales with the diameter.

Similar tradeoffs may also affect the minimum detectable irradiance and damage threshold for the ACNTC. The minimum irradiance may be determined by the Johnson noise. For the devices shown in FIG. 4, this is Eₘᵢₙ=14 μW/cm². A damage threshold for an ACNTC device may be determined by a maximum irradiance the device can withstand. Full coupled thermomechanical models predict that gold antennas may melt before thermal stress damages them (the thermal stress may actually help by deflecting the antennas slightly out of the focus of the reflector). This may also be influenced by the thermal resistance. Estimating the maximum irradiance from a conservative estimate of the melting point of gold gives Eₘᵢₙ=10.5 W/cm². This corresponds to a dynamic range of 58 dB.

A second significant improvement of the embodiments herein may include other selections of the metals for the nanothermocouple (NTC), which may improve the Seebeck coefficient more than 100 times. ACNTCs may be built from Ni and Pd with ΔS=8.91 μV/K using Pd as the antenna. The results in FIGS. 6 and 7 used properties for a Type K (Chromel/Alumel) with ΔS=41 μV/K. Other thermocouples for use in the embodiments described herein may be made from Constantan (NiCu) and/or Nichrome (NiCr), which has ΔS=63.2 μV/K. Such a change may result in a seven-fold sensitivity increase. In addition, using highly efficient thermoelectric materials (high-ZT materials), such as Bi₂Te₃, PdTe, or degenerately doped Si, would further increase their sensitivity. Using high-ZT materials for ACNTCs may therefore be beneficial in two ways: the thermal and electrical conductivity may be modified separately to minimize heat loss through the lead lines; and the relative Seebeck coefficient of such materials is much larger, for example on the order of a few hundred μV/K with optimum performance from the best combination of thermal resistance and electrical sensitivity. Table 1 summarizes targets of example devices made with a Chromel/Alumel thermocouple. As mentioned previously, when considering the sensors/area, equivalent D* could exceed 10¹⁰ Jones for 5 antennas.

TABLE 1

| Parameter | Value | |
|---|---|---|
| Aperture Efficiency | >0.15 | |
| Voltage Responsivity | >225 | V/W |
| Noise (Jolmson) | <3 | nV/Hz^{1/2} |
| Single Antenna D* | >2 × 10⁹ Jones | |
| Operating Temperature | 0-800 | K |
| Spectral Range | 2-200 | μm |
| Polarization Resolution | >10:1 | |
| Cutoff Frequency | >50 | kHz |

| | |
|---|---|
| External Bias | No |

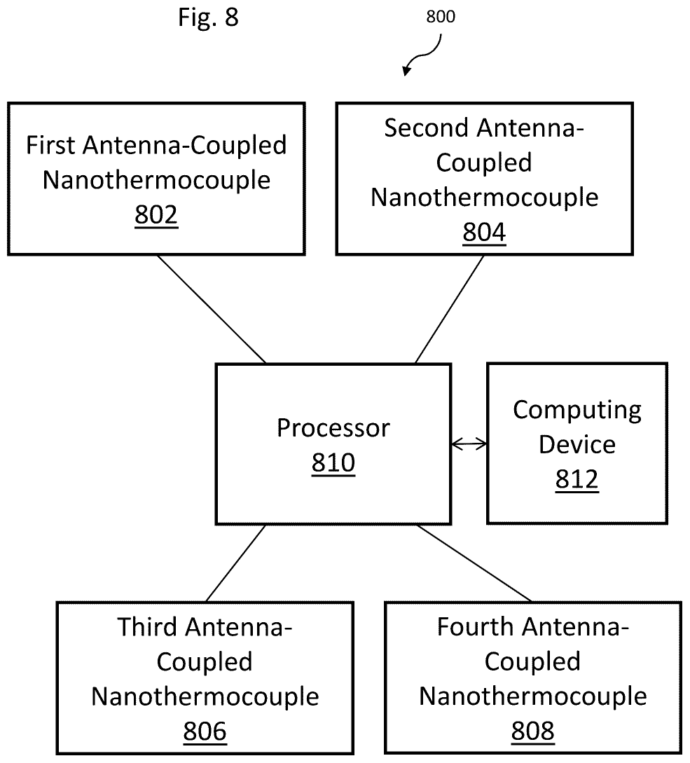

FIG. 8 illustrates an example system 800 for using an ACNTC array in accordance with embodiments of the present disclosure. For example, the system 800 may include first, second, third, and fourth ACNTCs 802, 804, 806, and 808, like an array of four cavities with antennas as shown in FIG. 4. Like in FIG. 4, there may be lead lines, through silicon vias (TSVs), wiring, etc. that connects the ACNTCs 802, 804, 806, and 808 to a processor 810 or other sensing and output circuitry so that the properties of an incoming wave may be interpreted, output, etc. The processor 810 and/or other sensing circuitry may be located on a same chip as the ACNTCs 802, 804, 806, and 808, may be located off-chip, or a combination thereof. The substrate or chip (e.g., as shown in FIG. 4) may further have circuitry, wiring, etc. (not shown in FIG. 4) to connect the processor 810 and/or other sensing, measurement, or output circuitry to a computing device 812. The computing device may be part of a larger system, and my use the output from the processor 810 or other circuitry to adjust a physical or electronic component of another device. The computing device 812 may also be used to visualize data captured by the ACNTCs 802, 804, 806, and 808 and/or interpreted by the processor 810 and/or other circuitry. For example, the processor 810 may be configured to determine an angle of incidence of electromagnetic waves to which system 800 and the ACNTCs 802, 804, 806, and 808 is exposed. The processor may further be configured to output an image where the ACNTCs 802, 804, 806, and 808 are configured as a Shack-Hartmann type imaging sensor, or the data output by the processor 810 may be formed into an image by the computing device 812. That image may be formed based at least in part on the angle of incidence detected by the ACNTCs 802, 804, 806, and 808, and may represent an IR image.

Besides HEL attacks, the apparatuses described herein may also be used on other defense applications, such as multispectral imaging across a broad range of IR wavelengths, low SWaP-C imaging for nanosatellites, secure communications at MHz frequencies with polarized IR signals that may be hidden in background radiation fields, THz detection and imaging, and/or as sources of low-intensity IR to THz radiation.

For example, various embodiments described herein may be used for laser detection. TECNAs as described herein have wavelength, angle-of-incidence, polarization, and coherence selectivity along with the speed to track modulation. Such properties may be used for detection of blinding attacks. Directed energy (e.g., burning up a structure) and designators may be at shorter wavelengths. However, satellites, unmanned aerial vehicles (UAV), and other sensing platforms may be vulnerable to the wavelengths that they are intended to sense. This means an advisory can blind temporarily or permanently a sensor. TECNAs may react fast enough (e.g., to have them function as a fast burn fuse) to detect and resolve the nature and origin of an attack. As such, an attack may be quickly sensed and sensitive electronics may be turned off or recalibrated to avoid damage by such an attack. Since the embodiments herein can measure aspects of incoming waves, they may also be useful for countermeasures of an attack. For example, the sensors herein may be used to home in on a laser source. The embodiments herein may also be useful for communications applications. The atmosphere is particularly transparent in the 3-5 μm window as well as 8-13 μm. Free-space communication both point-to-point on earth or from earth to satellites may utilize a fast detector to resolve this information. The directional nature of the sensors herein may be used to filter out directional noise or jamming as does the polarization resolution, combined with the fast, this allows different modes of keying. For example, switching between circular polarization states may be utilized for different modes of keying. The embodiments herein may also be useful for lens-free IR imaging. TECNAS described herein have angle-of incidence detection along with the ability to utilize this functionality geometrically over a large array. Images may be formed by resolving the angular and spatial variation in incident radiation. Lenses do this for visible light and can recreate a 2D image from a focal plane. This does not require postprocessing. However, TECNAs described herein provide the basis for angular and spatial diversity to resolve an incident IR radiation field. An image may be digitally created by constructing the signals from a large array as a superposition of point sources in space. Computation may be required but compressive imaging techniques may be used. Thus IR imagers may be utilized that do not require lenses, reducing space, weight, cost, etc. of IR imaging.

The embodiments herein may also be useful for lightweight spectrometers. TECNAs described herein have spectral selectivity that may be easily reconfigured across an array with minimal/no optics. An array of TECNAs with different spectral responses may act as a spectrometer. While the bandwidth of an individual antenna is not narrow, the ability to repeatably pattern multiple antennas with closely spaced antennas permits the effective spectral resolution to be significantly enhanced. TECNAs as described herein may be sensitive across the molecular fingerprint region of the spectrum and the speed leads to rapid detection of chemical signatures in a very compact package. For example, cell phone-based Fourier transform infrared (FTIR)-like chemical detectors could be used or small UAVs may have sensors that could fly through an effluent cloud.

The embodiments herein may also be useful for uncooled thermal imagers. TECNAs herein may have the sensitivity of microbolometers but with speeds more than 100-500× better and significantly better SWaP-C than cooled detectors. For example, embodiments herein may provide very fast sensing for UAVs, weapon sights, and/or other imagers (e.g. scientific or manufacturing imagers) where motion blur may be of concern. Ultralight imaging platforms may also utilize the technology where the weight of other imagers that use heavy components like a cryocooler are undesirable. Embodiments herein may also extend imaging to the THz range. Embodiments herein may also provide for astronomical imaging at different wavelengths. Embodiments herein may also provide for polarimetric resolved imaging (e.g., using linear or spiral antennas as described herein). The ability to resolve a Stokes vector may give advantages for detecting manmade and natural targets, including defeating camouflage. Imaging of solar cells with the embodiments herein may also yield valuable information. Embodiments herein may also provide for multispectral resolved imaging. This may include the THz and may combine spectrometer aspects and sensing for lightweight applications to allow pseudo-color vision in the mid/long-wave/THz. Specifically, an imager may be designed to resolve specific compounds (e.g., SF₆ or methane) in a compact imager without a color wheel. Applications may include looking for leaky transformers, detecting poison gas, or mapping soil concentrations from UAVs, or minerals on mars from a rover. The response from nanoantennas with different spectral responses may be added to a system or array to synthesize arbitrary or desired response functions. That is, the individual nanoantennas in a device may be configured to form different basis functions (e.g., ones that are not necessarily orthogonal). With a known family of basis functions these different nanoantennas may carry through an integration with incident spectra so that the presynthesized spectra acts as an effective filter for desired compounds, etc. as desired based on the nanoantennas selected for a given implementation. That is, a sufficiently large number of nanoantenna responses could be used to generate linear combinations to create a response from a specific function. These responses may then be applied in parallel to unknown incident fields to identify lasers or whether the incident fields match one or more specific chemical fingerprints, for example.

Embodiments herein may also provide for fast point-based IR radiation sensors since TECNAs herein have spectral selectivity and high speed). Such embodiments may be useful for pyrometry and fast accurate temperature measurements. For example, a cheap handheld IR thermometer may be implemented that is faster and able to compensate for surface emissivity. Embodiments herein may also provide for Shack-Hartmann sensor type imaging as TECNAs AOI selectivity allows resolution of the angular IR radiation field. This may be immediately useful for quantifying the performance of IR optics that are not transmissive to other wavelengths. Such embodiments may also be useful for characterizing laser beams in a laboratory.

As such, the various embodiments herein provide for TECNAs that may be used for a variety of purposes in a variety of implementations. Such uses as described herein may include, but are not limited to: (1) ACNTCs using the cavity or cavities described herein to provide angle of incidence (AOI) selectivity for incoming radiation; (2) ACNTCs using cavity coupling to enhance the response by electromagnetic (EM) coupling (e.g., on devices with smaller cavities less than 50 μm); (3) ACNTCs where there are multiple antennas above a single larger cavity (e.g., cavities of 50 μm or larger); (4) ACNTCs built around spiral antennas for broadband linear polarization or circular polarization (CP) selective absorption; (5) ACNTCs where the spectral selectivity of the antenna/cavity is used for spectroscopy; (6) ACNTCs where signals from multiple elements are synthesized to create an arbitrary spectral response; (7) ACNTCs where the atmosphere is removed (e.g., a vacuum is formed in the cavity) to improve the performance; (8) ACNTCs where the interference between the substrate and device with the multiple antennas is used to estimate the pulse length/coherence of a laser beam; (9) ACNTCs where the lead lines are advanced semiconductors (e.g., tellurium (Te) semiconductors, Bismuth Telluride semiconductors, or any other desired semiconductor material), such as a high ZT material semiconductor; (10) ACNTCs in arrays for laser detection; (11) ACNTCs in arrays for imaging (e.g., as a Shack-Hartmann sensor); (12) ACNTCs in arrays for spectroscopy; and/or (13) ACNTCs in arrays combined with machine learning for laser detection, imaging, and/or spectroscopy.

Although certain example methods, apparatuses, and computer readable media have been described herein, the scope of coverage of this patent is not limited thereto. On the contrary, this patent covers all methods, apparatus, computer readable media, and articles of manufacture fairly falling within the scope of the appended claims either literally or under the doctrine of equivalents.

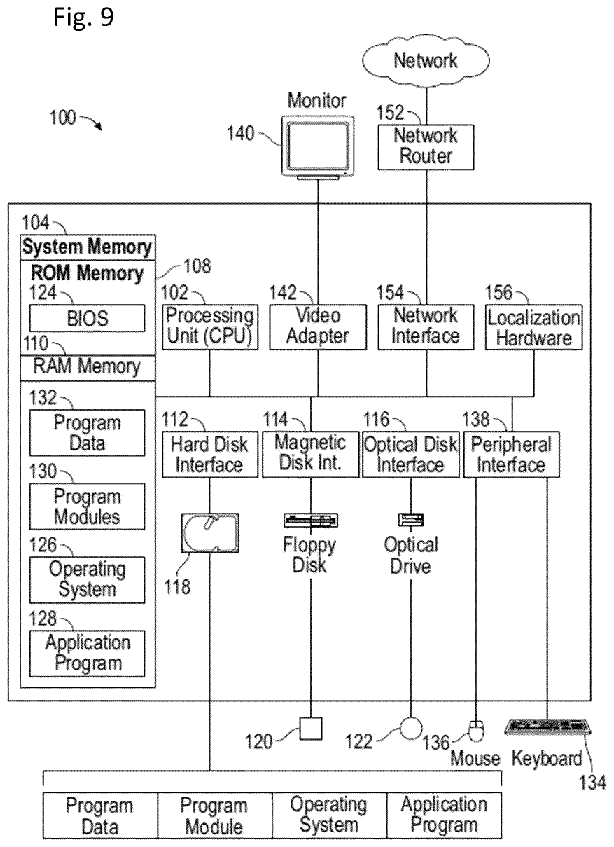

FIG. 9 is a diagrammatic view of an example embodiment of a computing environment that includes a general-purpose computing system environment 100, such as a desktop computer, laptop, smartphone, tablet, or any other such device having the ability to execute instructions, such as those stored within a non-transient, computer-readable medium. Any of the methods or systems described herein may be implemented on or executed by instructions stored upon a computing device that has any combination of the components shown in and described with respect to FIG. 8 (e.g., the processor 810 and/or the computing device 812).

Furthermore, while described and illustrated in the context of a single computing system 100, those skilled in the art will also appreciate that the various tasks described herein may be practiced in a distributed environment having multiple computing systems 100 linked via a local or wide-area network in which the executable instructions may be associated with and/or executed by one or more of multiple computing systems 100.

In its most basic configuration, computing system environment 100 typically includes at least one processing unit 102 and at least one memory 104, which may be linked via a bus 106. Depending on the exact configuration and type of computing system environment, memory 104 may be volatile (such as RAM 110), non-volatile (such as ROM 108, flash memory, etc.) or some combination of the two. Computing system environment 100 may have additional features and/or functionality. For example, computing system environment 100 may also include additional storage (removable and/or non-removable) including, but not limited to, magnetic or optical disks, tape drives and/or flash drives. Such additional memory devices may be made accessible to the computing system environment 100 by means of, for example, a hard disk drive interface 112, a magnetic disk drive interface 114, and/or an optical disk drive interface 116. As will be understood, these devices, which would be linked to the system bus 306, respectively, allow for reading from and writing to a hard disk 118, reading from or writing to a removable magnetic disk 120, and/or for reading from or writing to a removable optical disk 122, such as a CD/DVD ROM or other optical media. The drive interfaces and their associated computer-readable media allow for the nonvolatile storage of computer readable instructions, data structures, program modules and other data for the computing system environment 100. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 100.

A number of program modules may be stored in one or more of the memory/media devices. For example, a basic input/output system (BIOS) 124, containing the basic routines that help to transfer information between elements within the computing system environment 100, such as during start-up, may be stored in ROM 108. Similarly, RAM 110, hard drive 118, and/or peripheral memory devices may be used to store computer executable instructions comprising an operating system 126, one or more applications programs 128 (which may include the functionality disclosed herein, for example), other program modules 130, and/or program data 122. Still further, computer-executable instructions may be downloaded to the computing environment 100 as needed, for example, via a network connection.

An end-user may enter commands and information into the computing system environment 100 through input devices such as a keyboard 134 and/or a pointing device 136. While not illustrated, other input devices may include a microphone, a joystick, a game pad, a scanner, etc. These and other input devices would typically be connected to the processing unit 102 by means of a peripheral interface 138 which, in turn, would be coupled to bus 106. Input devices may be directly or indirectly connected to processor 102 via interfaces such as, for example, a parallel port, game port, firewire, or a universal serial bus (USB). To view information from the computing system environment 100, a monitor 140 or other type of display device may also be connected to bus 106 via an interface, such as via video adapter 132. In addition to the monitor 140, the computing system environment 100 may also include other peripheral output devices, not shown, such as speakers and printers.

The computing system environment 100 may also utilize logical connections to one or more computing system environments. Communications between the computing system environment 100 and the remote computing system environment may be exchanged via a further processing device, such a network router 152, that is responsible for network routing. Communications with the network router 152 may be performed via a network interface component 154. Thus, within such a networked environment, e.g., the Internet, World Wide Web, LAN, or other like type of wired or wireless network, it will be appreciated that program modules depicted relative to the computing system environment 100, or portions thereof, may be stored in the memory storage device(s) of the computing system environment 100.

The computing system environment 100 may also include localization hardware 186 for determining a location of the computing system environment 100. In embodiments, the localization hardware 156 may include, for example only, a GPS antenna, an RFID chip or reader, a WiFi antenna, or other computing hardware that may be used to capture or transmit signals that may be used to determine the location of the computing system environment 100.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments.

It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. An apparatus comprising:
a first antenna suspended over a cavity at a first position;
a first thermocouple connected to the first antenna, wherein the first thermocouple supports the first antenna over the cavity and extends from the first antenna to a first location on an edge of the cavity;
a second antenna suspended over the cavity at a second position different from the first position; and
a second thermocouple connected to the second antenna, wherein the second thermocouple supports the second antenna over the cavity and extends from the second antenna to a second location on the edge of the cavity different than the first location.

2. The apparatus of claim 1, wherein the first antenna is configured to produce heat upon exposure to an electromagnetic wave.

3. The apparatus of claim 2, wherein the first thermocouple is configured to convert the heat produced by the first antenna into an electrical signal.

4. The apparatus of claim 3, wherein the electrical signal output by the first thermocouple in response to a first electromagnetic wave of a first angle of incidence is different than the electrical signal output by the first thermocouple in response to a second electromagnetic wave of a second angle of incidence different from the first angle of incidence.

5. The apparatus of claim 1, wherein the first thermocouple further extends from the first antenna to a third location on the edge of the cavity.

6. The apparatus of claim 5, wherein the second thermocouple further extends from the second antenna to a fourth location on the edge of the cavity.

7. The apparatus of claim 1, further comprising:
a third antenna suspended over the cavity at a third position different from both of the first position and the second position; and
a third thermocouple connected to the third antenna, wherein the third thermocouple supports the third antenna over the cavity and extends from the third antenna to a third location on the edge of the cavity different than both of the first location and the second location.

8. The apparatus of claim 7, further comprising:
a fourth antenna suspended over the cavity at a fourth position different from each of the first position, the second position, and the third position; and
a fourth thermocouple connected to the fourth antenna, wherein the fourth thermocouple supports the fourth antenna over the cavity and extends from the fourth antenna to a fourth location on the edge of the cavity different than each of the first location, the second location, and the third location.

9. The apparatus of claim 1, wherein each of the first antenna and the second antenna are dipole antennas.

10. The apparatus of claim 1, further comprising a third antenna suspended over the cavity at a third position different from both of the first position and the second position, wherein the first thermocouple is connected to the third antenna and comprises:
a first portion extending from the first antenna to the first location on the edge of the cavity,
a second portion extending from the first antenna to the third antenna, and
a third portion extending from the third antenna to a third location on the edge of the cavity.

11. The apparatus of claim 10, wherein the first thermocouple further comprises a fourth portion extending from the third portion to a fourth location on the edge of the cavity.

12. A method of using the apparatus of claim 1 as an infrared light sensor.

13. An apparatus comprising:
a first antenna suspended over a first cavity;
a first thermocouple connected to the first antenna, wherein the first thermocouple supports the first antenna over the first cavity and extends from the first antenna to an edge of the first cavity;
a second antenna suspended over a second cavity different from the first cavity; and
a second thermocouple connected to the second antenna, wherein the second thermocouple supports the second antenna over the second cavity and extends from the second antenna to an edge of the second cavity.

14. The apparatus of claim 13, further comprising a processor electrically connected to the first thermocouple and the second thermocouple.

15. The apparatus of claim 14, wherein the processor is configured to determine a first angle of incidence of electromagnetic waves to which the first antenna is exposed and determine a second angle of incidence of electromagnetic waves to which the second antenna is exposed, wherein the first antenna and the second antenna are oriented in different planes such that the first antenna and the second antenna are exposed to the electromagnetic waves at different angles of incidence.

16. The apparatus of claim 15, wherein the processor is configured to output an image based at least in part on the first angle of incidence and the second angle of incidence.

17. The apparatus of claim 16, wherein the electromagnetic waves comprise infrared light, and further wherein the image comprises a representation of the infrared light sensed at the first antenna and the second antenna.

18. The apparatus of claim 13, wherein the first cavity and the second cavity are each semi-spherical.

19. The apparatus of claim 18, wherein the first antenna is located at or near a focal point of the first cavity.

20. A method of using the apparatus of claim 13 as a wavefront sensor.

21. The apparatus of claim 13, wherein the first antenna and the second antenna each comprise a spiral antenna, wherein the spiral antenna is configured to remove linear polarization response and provide circular polarization selectivity.

22. The apparatus of claim 13, further comprising a first lead line connected to the first thermocouple, wherein at least one of the first lead line or the first thermocouple comprises a semiconductor material.

23. The apparatus of claim 22, wherein the first antenna is comprised of a metal.

24. The apparatus of claim 23, wherein the at least one of the first lead line or the first thermocouple is further comprised of Bismuth Telluride or other high ZT material.

25. The apparatus of claim 13, wherein the apparatus is hermetically sealed and the cavity contains a vacuum.

26. The apparatus of claim 25, wherein the pressure within the cavity is adjustable to trade sensitivity of the apparatus for response time.

27. The apparatus of claim 13, further comprising a plurality of additional cavities each having a single antenna.

28. The apparatus of claim 27, further comprising a processor configured to combine responses from multiple antennas to synthesize an arbitrary spectral response from the multiple antennas.

29. The method of using the apparatus of claim 27, as an ultra-low weight spectrograph.

30. The apparatus of claim 13, further comprising a processor configured to determine an estimated pulse length or coherence of a laser beam based on an interference between measured first radiation reflecting off a first surface of a substrate in which the first cavity is formed and measured second radiation reflecting of a second surface of the substrate as determined at multiple antennas of the apparatus.

31. An apparatus comprising:
a single antenna suspended over a cavity, wherein the cavity is generally semi-spherical in shape, and further wherein the single antenna is the only antenna suspended over the cavity; and
a thermocouple connected to the single antenna, wherein the thermocouple supports the single antenna over the cavity and extends from the single antenna to a location on an edge of the cavity.
